(19) United States
(12) Patent Application Publication
(10) Pub. No.: US 2002/0180206 A1
(43) Pub. Date: Dec. 5, 2002

(54) Souvenir or promotional article, method of forming same and method of using same

(76) Inventor: Douglas A. Tronrud, Menomonie Township, WI (US)

Correspondence Address: Truesdale Law Office, 642 Nightingale Blvd., Stillwater, MN, 55082, US

(21) Appl. No.: 09/867,074

(22) Filed: May 29, 2001

(51) Int. Cl. B42D 15/00

(52) U.S. Cl. 283/107

(57) ABSTRACT

The present invention provides an article. The article has at least three perimeter edges and a front surface and back surface with smooth rounded corners at the angular perimeter portions thereof. The article is divided into at least two card portions having indicia on at least a portion of one surface. Means for separating the card portions are provided and the article is formed such that when the card portions are separated, each card portion has smooth rounded corners at the angular perimeter portions thereof. Also provided are a method of making the article and a method of using the article.

### FIELD OF THE INVENTION

The present invention relates to articles such as those which can be distributed for various purposes such as identification, discount cards for sales purposes, telephone calling cards or as souvenir mementos for events.

### BACKGROUND OF THE INVENTION

Various types of plastic or laminated plastic articles have been developed over the years. Such articles include driver's licenses, identification cards, credit cards, telephone calling cards, and discount cards. Other articles such as playing cards, waterproof artwork and mazelike amusement devices have also been developed using plastic lamination methods.

Laminated playing cards have been disclosed which include a paper stock base with opaque printed paper layers adhered to each side of the base. The composite is encased between layers of clear plastic film and then mechanically embossed to provide a non-slip surface.

A maze amusement device of laminated construction has also been disclosed. A card is printed to provide maze designs on each side, one the mirror of the other such that the lines forming the maze on one side have opposing lines on the opposite face. The card is laminated between layers of plastic film. Gates are marked on each side, gates on one side opposite gates on the other side forming imaginary access ports through the card. The outer plastic layers are capable of having lines drawn on such layers by, e.g., a marking pen, to play a game with the maze device, which lines can be removed after each use.

Also known is a primary plastic card having indicia on each face thereof and, as removable portions of the card, a wallet sized card having a magnetic strip portion and circular coupon portions. The card bearing the magnetic strip and the coupons having perforations defining the perimeters of the card bearing the magnetic strip and the coupons. The perforations provide means for removal of the card bearing the magnetic strip and/or the coupons from the primary card.

Further known is a plastic card having straight sides and rounded corners with a wallet size card portion bearing indicia and a smaller portion bearing related indicia. The portions are defined and made separable by a perforated line. The card, as presented, has a telephone calling card as a portion thereof.

Where cards are provided with separable portions, at least one or more of the separable portions generally has undesirable sharp corners which can injure the user or various materials with which the card may come into contact. The card may also be lacking in aesthetic qualities.

### SUMMARY OF THE INVENTION

The present invention, in one aspect, provides an article, the article having at least three perimeter edges; a front surface and a back surface with smooth rounded corners at the angular perimeter portions thereof; the article being divided into at least two card portions and having indicia on at least a portion of one surface; means for separating the card portions; and the article being formed such that when the card portions are separated, each card portion has smooth rounded corners at the angular perimeter portions thereof.

The article, which can also be termed a card, can be formed, for example, of paper, card stock, plastic sheet or moldable plastic, wood veneer, leather, foil or other such substantially thin materials. Various combinations of card material can also be used to form the card. The card preferably has at least the outer surfaces thereof formed of plastic material to enhance the longevity of the card. The card material can be formed by well-known methods.

The card can be of any shape or size but, generally preferred for convenience, the card has at least one portion thereof being substantially wallet sized, i.e., of rectangular shape with dimensions of about two inches in height by about three inches in width.

Various indicia can be located on one or both surfaces of the card, the indicia serving to provide desired lettering, numbers, designs, photographs, holograms and the like on the card, such as well-known to those skilled in the art. For example, as part of the indicia on the card surface, bar codes may be printed for various purposes. Data may be presented for business purposes. Holograms may be included for decorative purposes or to deter unwanted duplication. Designs or likenesses of celebrities can be a part of the indicia such that card portions can serve as collector or souvenir cards.

The card can also have indicia on both the front and back surfaces, each surface of a card portion having closely related indicia to serve similar purposes such as character likenesses with different poses on each side of one portion to provide a collector or souvenir card, the other portion having indicia which could serve as a ticket stub. A card having indicia on both sides can serve to promote a product using similar or different indicia on each side of one portion, the other portion having indicia thereon to provide a discount coupon for a product or service. The card indicia can also serve many other almost limitless purposes as can be determined by the designer or developer preparing the indicia.

A card portion can have portals therein to provide means for hanging such as, for example, on a key chain, neck chain, or a vertical surface such as a wall, desk, or office cubicle divider. A card portion can have attached to one face thereof a magnetic strip such that the card portion can be appended to a metal surface such as, for example, a refrigerator.

Further, a card portion can have a machine readable magnetic strip formed thereon for identification or other such well-known purposes. Items may be attached to the card or portion thereof of the invention. Such items which may be attached to the card or portion thereof include, for example, tickets, coupons, character figurines, or identification to be temporarily adhered to a wearer's clothing or adhered to a person such as a temporary tattoo. All such additions to the card being well known to those skilled in the art.

The present invention, in another aspect, provides a method of forming an article comprising the steps of 1) providing a substantially flat material having a front surface and a back surface and capable of being formed in a desired shape; 2) forming the article such that at least three perimeter edges are formed and the angular portions thereof are provided with smooth rounded corners; 3) providing means such that the article is capable of being separated into at least two portions; and 4) providing the article, in the forming step, with curved portions at the perimeter edges thereof proximate the means for separating such that, upon separation, each portion has smooth rounded corners at the angular perimeter portions thereof.

The article, or card, can be formed by cutting, stamping, molding, and other such methods well-known to those skilled in the art. Combinations of such methods may also be used to form the card.

Rectangular or square cards are generally preferable for most purposes, although other shapes can be used to satisfy special requirements. The means provided to make separable certain portions of the card can be perforations, scoring or other means again well-known to those skilled in the art. A card portion can have portals provided therein. Such portals can be provided at the time the card is being formed or subsequently by means such as punching and the like.

The present invention, in yet another aspect, provides a method of using an article, the steps comprising

1) providing an article having at least three perimeter edges; a front surface and a back surface with smooth rounded corners at the angular perimeter portions thereof; the article being divided into at least two card portions and having indicia on at least a portion of one surface; means for separating the card portions; and the article being formed such that when the portions are separated, each portion has smooth rounded corners at the angular perimeter portions thereof; and

2) separating the card portions.

### BRIEF DESCRIPTION OF THE DRAWINGS

FIGS. 1 and 2 are views of one surface of articles of the present invention.

FIG. 3 is a cross-sectional view of FIG. 2.

FIG. 4 is a cross-sectional view of an embodiment of the invention.

FIG. 5 is a perspective view of an embodiment of the invention.

FIGS. 6, 7, 8, and 9 are views of one surface of additional embodiments of the invention.

FIG. 10 is a view of one surface of an article of the present invention.

### DETAILED DESCRIPTION OF THE INVENTION

With reference to the drawings, like reference numbers designate like or corresponding elements of the invention throughout the several views.

FIG. 1 is a top view of one surface of card 10, a preferred embodiment of the invention. Card 10, having portions 12 and 14, is provided with smooth rounded corners 16a, 16b, 16c, and 16d at the angular perimeter portions thereof. Perforations 18 are provided between card portions 12 and 14 such that card portions 12 and 14 are separable. At the juncture of card portions 12 and 14, curved portions 17a, 17b, 17c, and 17d are provided on the outer edges of card 10. the opposing side (not shown). Card portion 24 is provided with portal 29 which may be used to allow the card holder, for example, to attach card portion 24 to a key ring or append card 24 from a neck chain.

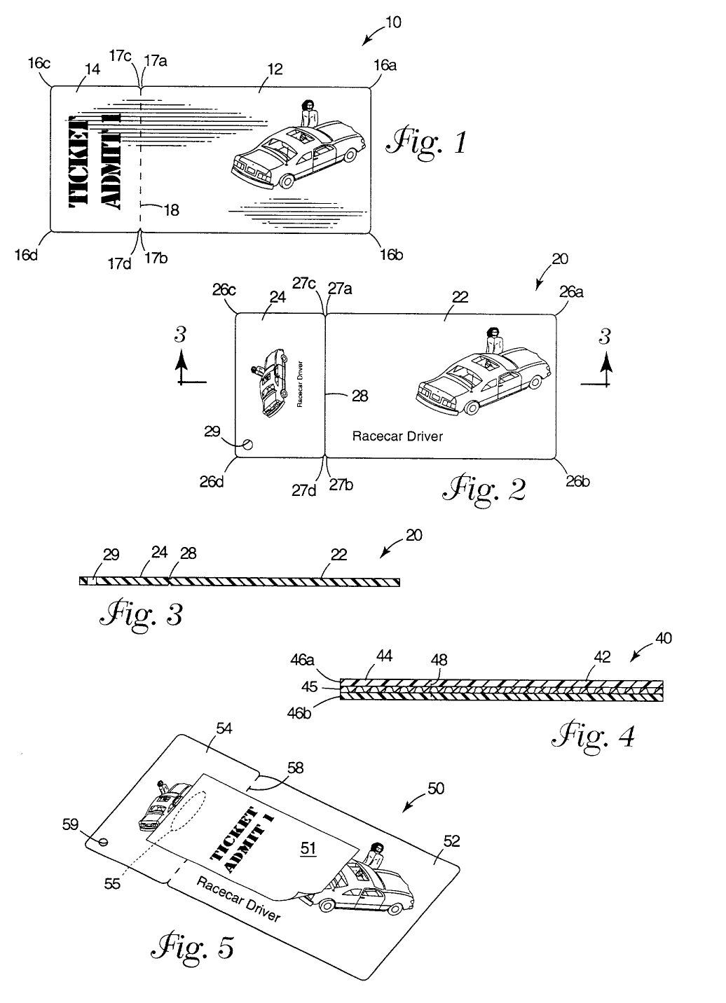

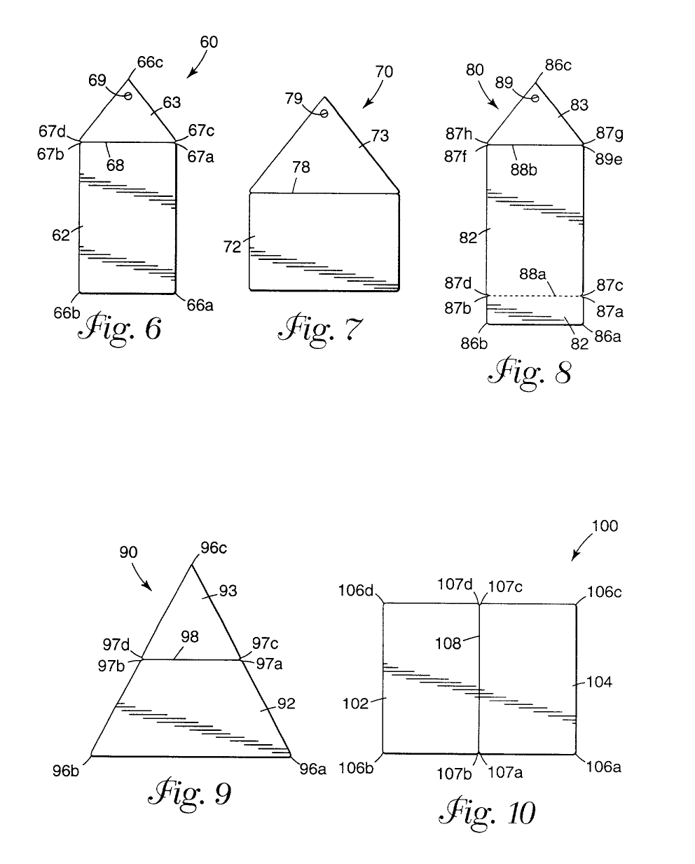

FIG. 3 is a cross-sectional view of card 20 of the present invention formed of a single layer of plastic material and having card portions 22 and 24. The card has score line 38 along which card portions 22 and 24 can be separated and portal 29 through which, for example, a key ring, key chain, neck chain or thumb tack may be placed.

FIG. 4 is a cross-sectional view of a card of the invention. Card 40 is a multiplayer construction having core 45 of paper, card stock, plastic, foil or other thin material encased between layers 46a and 46b which are preferably formed of a plastic material. Perforation 48 is provided to enable separation of card portions 42 and 44.

The indicia on card 40 may be applied on one or both surfaces of core 45 and then covered by transparent or translucent layers of plastic. Preferably, plastic layers 46a and 46b are thermoplastic and can be adhered to core 45 using heat and/or pressure. Alternatively, plastic layers 46a and 46b can be applied by coating or other methods well-known in the art. Layers 46a and 46b may carry indicia in the absence of or in addition to any indicia on core 45. Layers 46a and/or 46b may be formed with indicia in the plastic layer or formed on the surface thereof. Surface indicia may be applied to layer 46a and 46b by well-know means such as, for example, roller printing, screen printing or heat transfer methods. Special effects may be provided by special design of printing on core 45 and layers 46a and 46b as is well-known to those skilled in the art.

Whether the card is of a single layer, three layers as shown in FIG. 4 or of any number of multiple layers it is understood that the card of the invention can be as flexible or as stiff as the designer thereof chooses.

FIG. 5 is a perspective view of card 50 of the present invention. Card 50 is similar to card 20 except that the score line is replaced by perforations 58. Card 50 has rounded corners and curved edge portions proximate perforations 58. Also provided on card 50 is a removable layer 51 which may be smaller than, the same size as or larger than card 50.

Layer 51 may serve as a ticket stub as shown or as a myriad of other purposes which can be determined by the designer of such a card. Removable layer 51 may be placed on either surface of card 50 or the same or different removable layers may be placed on each surface of card 50. Layer 51 can be of any sheet material desired by a designer such as, for example, paper, plastic film, foil or other material well-known to those skilled in the art.

Layer 51 may be attached to card 50 in any manner which permits removal of layer 51. Included, for example, are hot-melt adhesives or adhesives such as those used on Scotch™ Removable Magic™ Tape and other such products. Layer 51 can be adhered to card portion 54, as shown, to card portion 52 or to both card portions 52 and 54. Layer 51 can bear indicia for such purposes as desired such as, for example, a ticket stub, as shown, advertising, directions for possible uses of card 50 and the like.

FIG. 6 shows a further embodiment of a card of the present invention. Card 60 is provided with rectangular card portion 62 and triangular card portion 63 having a perforation therebetween for separability purposes. Smooth rounded corners 66a, 66b and 66c are provided as well as curved portions 67a, 67b and 67c which provide smooth rounded corners on card portions 62 and 63 when such card portions are separated at score line 68. As described earlier, card 60 may be single- or multi-layer, may have portal 69, as shown, and may bear indicia as desired.

FIG. 7 shows card 70 which is similar to card 60 except that triangular card portion 73 is joined to rectangular card portion 72 at a longer edge of card portion 72 at score line 78 in contrast to card 60 where triangular card portion 63 is joined to rectangular card portion 62 at a shorter edge of card portion 62 at score line 68.

This embodiment of the invention, particularly when each card portion is substantially wallet, or credit card, size, is especially useful when the indicia on the card portions carries information such as, for example, telephone listings for businesses or groups or information for customers or clients which customers or clients could retain conveniently. One surface of one portion can be printed as a business card and the remaining surfaces can have indicia thereon such as, for example, corporate logos, advertising, sales information, or important telephone numbers not normally carried on business cards.

Various modifications and alterations of this invention will become apparent to those skilled in the art without departing from the scope and spirit of this invention, and it should be understood that this invention is not to be unduly limited to the illustrative embodiments set forth herein.

What is claimed is:

1. An article, said article having at least three perimeter edges; a front surface and a back surface with smooth rounded corners at the angular perimeter portions thereof; said article being divided into at least two card portions and having indicia on at least a portion of one surface thereof; means for separating said card portions; and said article being formed such that when said card portions are separated, each said card portion has smooth rounded corners at the angular perimeter portions thereof.

2. The article of claim 1 wherein said article is formed of paper, card stock, plastic sheet, moldable plastic, wood veneer, leather, foil or combinations thereof.

3. The article of claim 1 wherein said article has outer layers of plastic.

4. The article of claim 1 wherein one or both said surfaces bear indicia on at least a portion thereof.

5. The article of claim 4 wherein said indicia is lettering, numbers, designs, photographs, holograms, bar codes, data or combinations thereof.

6. The article of claim 5 wherein said both said surfaces bear indicia.

7. The article of claim 1 wherein said article carries a magnetic strip on one or more portions thereof.

8. The article of claim 1 wherein said article has a portal formed therein.

9. The article of claim 1 wherein said article has attached thereto an item.

10. The article of claim 9 wherein said item is a ticket, coupon, character figurine, material for identification purposes or a combination thereof.

11. The article of claim 9 wherein said item is attached to said article by adhesive, string, elastic material or a combination thereof.

12. The article of claim 1 wherein said means for separating said card portions are perforations, a score line or a combination thereof.

13. The article of claim 1 wherein at least one card portion thereof is substantially the size of a credit card.

14. The article of claim 1 wherein said article comprises two card portions.

15. The article of claim 14 wherein one card portion serves as a souvenir of an event and said other card portion serves as an admission ticket.

16. The article of claim 1 wherein said article comprises three card portions, one card portion serving as a souvenir card, another card portion serving as another souvenir and the remaining card portion serving as an admission ticket.

17. The article of claim 1 wherein portions of said article are flexible, stiff or a combination thereof.

18. A method of forming an article comprising the steps of
1) providing a substantially flat material having a front surface and a back surface and capable of being formed in a desired shape;
2) forming said article such that at least three perimeter edges are formed and the angular portions thereof are provided with smooth rounded corners;
3) providing means such that said article is capable of being separated into at least two card portions; and
4) providing said article, in the forming step, with curved portions at the perimeter edges thereof proximate said means for separating such that, upon separation, each said card portion has smooth rounded corners at the angular perimeter portions thereof.

19. The method of claim 18 wherein said article is formed by cutting, stamping, molding or combinations thereof.

20. A method of using an article, the steps comprising
1) providing an article having at least three perimeter edges; a front surface and a back surface with smooth rounded corners at the angular perimeter portions thereof; said article being divided into at least two card portions and having indicia on at least a portion of one surface; means for separating said card portions; and said article being formed such that when said card portions are separated, each said card portion has smooth rounded corners at the angular perimeter portions thereof; and
2) separating said card portions.
